(19) United States
(12) Patent Application Publication
(10) Pub. No.: US 2023/0091007 A1
(43) Pub. Date: Mar. 23, 2023

(54) INFORMATION PROCESSING DEVICE, INFORMATION PROCESSING METHOD, AND RECORDING MEDIUM

(71) Applicant: NEC Corporation, Tokyo (JP)

(72) Inventor: Fumiyuki MIYAHARA, Tokyo (JP)

(73) Assignee: NEC Corporation, Tokyo (JP)

(21) Appl. No.: 17/901,073

(22) Filed: Sep. 1, 2022

(30) Foreign Application Priority Data
Sep. 22, 2021 (JP) 2021-154412

(51) Int. Cl. G09B 7/02; G06F 16/28

(52) U.S. Cl. CPC G09B 7/02; G06F 16/285

(57) ABSTRACT

To provide useful information to a teacher so that the teacher who gives an online class can notice a sign of a problem of a student as soon as possible. A collection unit (11) collects keystroke data indicating an operation input amount to a user terminal, an extraction unit (12) extracts, from the keystroke data, a keystroke pattern indicating a feature of an operation input to the user terminal, and a classification unit (13) classifies approach of a student to a task, based on the keystroke pattern.

This application is based upon and claims the benefit of priority from Japanese Patent Application No. 2021-154412, filed on Sep. 22, 2021, the disclosure of which is incorporated herein in its entirety by reference.

### TECHNICAL FIELD

The present invention relates to an information processing device, an information processing method, and a program, and more particularly, relates to an information processing device, an information processing method, and a program that process log information or the like acquired from a user terminal.

### BACKGROUND ART

In general educational guidance in school, teachers create, after each class, records of content of class and how to proceed with the class (so-called class record) and reports on the progress status of learning for each student (so-called teaching report). When deciding the content of the next classes, teachers can accurately recall the content of the last classes by checking the created records.

Private businesses such as tutoring schools and preparatory schools have adopted more advanced information communication technology (ICT) systems.

For example, Patent Literature 1 (JP 2005-182272 A1) describes that using a management database and a curriculum database, a management program produces a learning instruction document to be given to an instructor, and produces an instruction report including advice to a student based on a learning result of the student. Patent Literature 2 (JP 2008-009876 A1) discloses a system that enables each of four parties of a room chief, teachers, students, and parents to transmit and receive data to and from a management server from a dedicated menu screen.

### SUMMARY

In future, each student can participate in online classes through a user terminal such as a tablet terminal and a personal computer by utilizing the improved ICT infrastructure. As a result, it is considered that opportunities to use various kinds of content such as digital textbooks and educational applications increase. In the online classes, it is difficult to directly observe the state of a student from the teacher's eyes.

Therefore, there is a demand for a mechanism for helping teachers to notice students' abnormalities, that is, signs of problems as soon as possible before the problems become apparent due to low grades of the students or the like.

The present invention has been made in view of the above problems, and an object of the present invention is to provide a technique for complementing students' approach to the tasks in online classes.

### BRIEF DESCRIPTION OF THE DRAWINGS

Exemplary features and advantages of the present invention will become apparent from the following detailed description when taken with the accompanying drawings in which:

FIG. 1 is a block diagram illustrating a configuration of an information processing device according to a first or second example embodiment;

FIG. 2 is a flowchart illustrating an operation of the information processing device according to the first or second example embodiment;

FIG. 3 is a view illustrating an example of keystroke data collected from a user terminal by the information processing device according to the first or second example embodiment;

FIG. 4 is a view illustrating a length of time for working on and a non-working time in one task in an example of keystroke data in one task;

FIG. 5 is a view illustrating an example of classification (first type to fourth type) of student's approach to the task;

FIG. 6 is a view schematically illustrating an example of time series of classification for one student;

FIG. 7 is a view illustrating one modification of the information processing device according to the second example embodiment, and is a view illustrating an example of keystroke data in two consecutive tasks;

FIG. 8 is a block diagram illustrating a configuration of an information processing device according to a third example embodiment;

FIG. 9 is a flowchart illustrating an operation of the information processing device according to the third example embodiment;

FIG. 10 is a view illustrating a second example of classification of student's approach to the task;

FIG. 11 is an example of combination of a student's keystroke pattern and a test result and an evaluation;

FIG. 12 is a view schematically illustrating an example of a configuration of a communication system including the information processing device according to any of the first to third example embodiments; and

FIG. 13 is a view illustrating an example of a hardware configuration of the information processing device according to the first to third example embodiments.

### EXAMPLE EMBODIMENT

Some example embodiments of the present invention will be described with reference to the drawings. In each of the following example embodiments, a “student” refers to a general person who takes a class related to study. The “student” may be anyone from a “pupil” having primary education to a “student” having higher education. The “student” may be not only a minor but also a majority, or may be an adult student (a student who participates in so-called recurrent education).

### First Example Embodiment

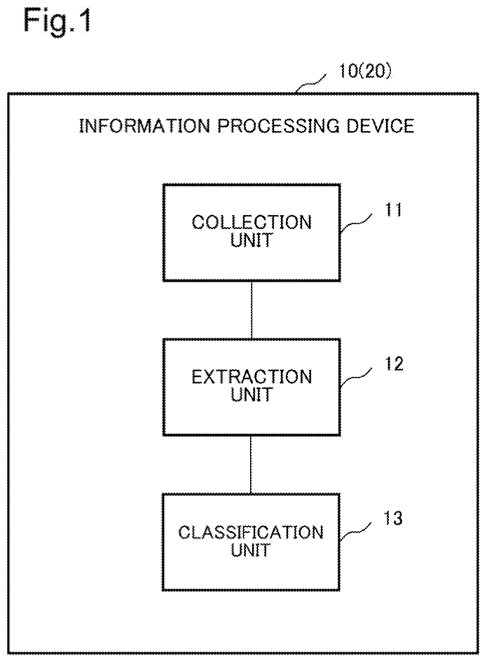

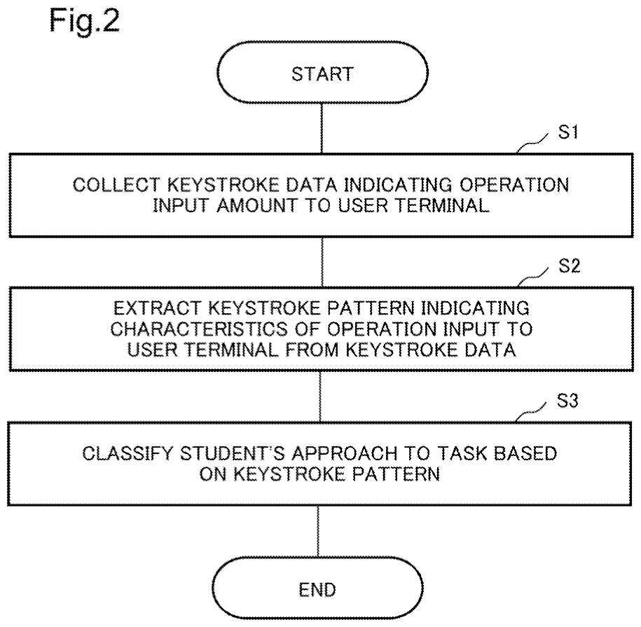

The first example embodiment will be described with reference to FIGS. 1 and 2.

### (Information Processing Device 10)

The configuration of an information processing device 10 according to the present first example embodiment will be described with reference to FIG. 1. FIG. 1 is a block diagram illustrating the configuration of the information processing device 10. As illustrated in FIG. 1, the information processing device 10 includes a collection unit 11, an extraction unit 12, and a classification unit 13. Each component of the information processing device 10 will be described below.

The collection unit 11 collects keystroke data indicating an operation input amount to a user terminal 100. The collection unit 11 is an example of a collection means.

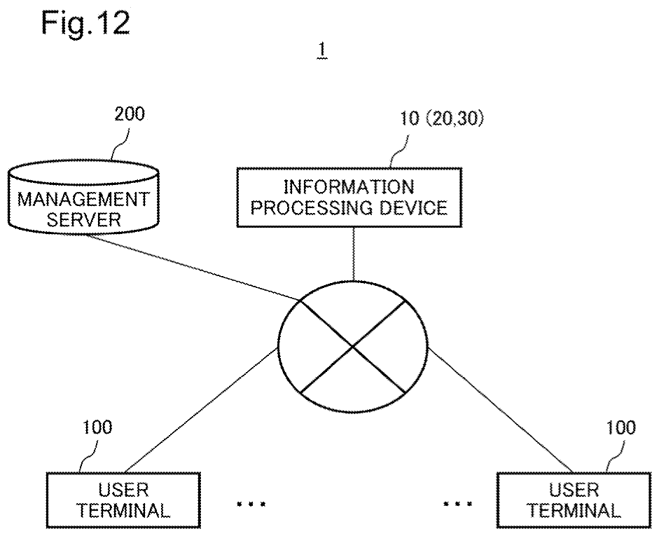

In one example, the collection unit 11 collects log information from the user terminal 100 (FIG. 12). For example, the collection unit 11 accesses the user terminal 100 through a discretionary communication network and requests the user terminal 100 to transmit log information. Alternatively, the user terminal 100 may be set such that log information is periodically transmitted from the user terminal 100 to the information processing device 10. The collection unit 11 collects the log information transmitted from the user terminal 100.

The collection unit 11 extracts keystroke data indicating an operation input amount to the user terminal 100 from the log information. The operation input amount to the user terminal 100 includes, for example, the number of keystrokes on a keyboard, the number of times of clicking and the number of times of scrolling with a mouse, the number of touches on a touchscreen, and the contact length of time onto a touch pad.

The log information includes the keystroke data described above. The log information may include at least one of an operation log, an authentication log, an access log, a communication log, a call log, and an event log.

Alternatively, the log information of the user terminal 100 may be temporarily stored in a management server 200 (FIG. 12). In this case, instead of collecting log information from the user terminal 100, the collection unit 11 can indirectly collect, from the management server 200, the log information transmitted from the user terminal 100.

The collection unit 11 outputs the collected keystroke data to the extraction unit 12.

The extraction unit 12 extracts a keystroke pattern indicating a feature of an operation input to the user terminal 100 from the keystroke data. The extraction unit 12 is an example of an extraction means.

In one example, the extraction unit 12 receives, from the collection unit 11, the keystroke data collected from the user terminal 100. The extraction unit 12 extracts keystroke data corresponding to one task from the keystroke data. The keystroke data corresponding to one task is keystroke data in a time period in which one task is performed. The extraction unit 12 extracts a keystroke pattern indicating a feature of an operation input to the user terminal 100 from the keystroke data corresponding to one task.

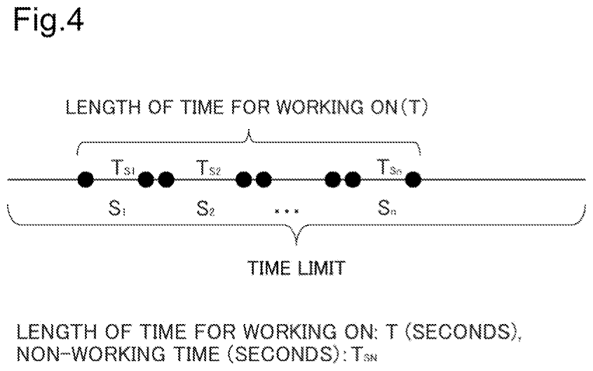

In one example, the extraction unit 12 extracts a non-working time rate and the length of time for working on from the keystroke data as a keystroke pattern. The non-working time rate represents a ratio of a length of time during which there is no operation input to the user terminal 100 to a time limit for a task (FIG. 4). The length of time for working on represents a length of time from when the task is started to when the last operation input to the user terminal 100 is made.

The method of operation input to the user terminal 100 is different depending on the student who uses the user terminal 100. Therefore, both the non-working time rate and the length of time for working on represent the personality of the student who uses the user terminal 100. For example, since an excellent student can immediately answer after a task is started, the student can immediately end the task. Therefore, both the non-working time and the length of time for working on are short. On the other hand, an earnest but not very excellent student answers little by little through trial and error, and therefore both the non-working time and the length of time for working on become long.

The keystroke pattern is not limited to the non-working time rate and the length of time for working on. In another example, the keystroke pattern may be a combination of the operation input amount, the non-working time, and the length of time for working on.

The extraction unit 12 outputs, to the classification unit 13, information indicating the keystroke pattern extracted from the keystroke data.

Based on the keystroke pattern, the classification unit 13 classifies student's approach to the task. The classification unit 13 is an example of a classification means.

In one example, the classification unit 13 receives information indicating a keystroke pattern from the extraction unit 12. Based on the keystroke pattern, the classification unit 13 analyzes how the student using the user terminal 100 is working on the task.

In the first example, the classification unit 13 compares the non-working time rate (an example of a keystroke pattern) with a first threshold value, and determines whether the non-working time rate exceeds the first threshold value. The first threshold value is determined based on the mean of the non-working time rates of all students in the class, for example. The classification unit 13 compares the length of time for working on (an example of a keystroke pattern) with a second threshold value, and determines whether the non-working time rate exceeds the second threshold value. The second threshold value is determined based on the mean of the lengths of time for working on of all the class members, for example.

The classification unit 13 classifies student's approach to the task based on the magnitude relationship between the non-working time rate and the first threshold value and the magnitude relationship between the length of time for working on and the second threshold value. In the present example, there are four types of student's approach to the task. A more detailed specific example will be described in the second example embodiment.

In the second example, the classification unit 13 classifies the features of the keystroke pattern into any class by using classification conditions. Each class corresponds to the type of student's approach to the task. The classification conditions are generated by machine learning of feature patterns of a large number of students.

In the third example, the classification unit 13 classifies student's approach to the task based on log information such as an operation log, an authentication log, an access log, a communication log, a call log, and an event log, in addition to the keystroke pattern.

For example, when a student talks with a teacher or an assistant about a task using a call function or a chat function of the user terminal 100, a communication log or a call log is left in the user terminal 100. By acquiring the log information from the collection unit 11 and analyzing the log information, the classification unit 13 confirms the presence or absence of communication or a call within the length of time for working on task.

The classification unit 13 subtracts the length of call time or the length of communication time from the length of time during which there is no operation input to the user terminal 100. In a case where the student is keystroking also during a call, and there is an operation input to the user terminal 100, the classification unit 13 adds the length of call time during keystroking back to the length of time during which there is no operation input to the user terminal 100. Then, the classification unit 13 sets the length of remaining time in which the length of call time or the length of communication time is subtracted as net non-working time. The classification unit 13 calculates, as a non-working time rate, a ratio of net non-working time to the time limit for a task.

Thereafter, the classification unit 13 classifies student's approach to the task based on the non-working time rate and the length of time for working on in a procedure similar to that in the first example.

As in some examples described above, the classification unit 13 classifies student's approach to the task.

Thereafter, the classification unit 13 may transmit information indicating the type for each student to the management server 200 (FIG. 12) via the communication network. The information indicating the type for each student is stored in the management server 200.

For example, the information processing device 10 may create a list of types for each student based on the information acquired from the management server 200 and display the list on a screen of a display unit of the user terminal 100, or may generate data of a screen displaying the list and output the data of the screen to an external monitor or the like. This allows the teacher to easily refer to or acquire the information stored in the management server 200 by connecting to the network using the user terminal 100.

### (Operation of Information Processing Device 10)

An example of the operation of the information processing device 10 according to the present first example embodiment will be described with reference to FIG. 2. FIG. 2 is a flowchart illustrating a flow of processing executed by each unit of the information processing device 10.

As illustrated in FIG. 2, the collection unit 11 collects keystroke data indicating the operation input amount to the user terminal 100 (S1). The collection unit 11 outputs the keystroke data collected from the user terminal 100 to the extraction unit 12.

The extraction unit 12 receives, from the collection unit 11, the keystroke data collected from the user terminal 100. The extraction unit 12 extracts, from the keystroke data, a keystroke pattern indicating a feature of an operation input to the user terminal 100 (S2). The extraction unit 12 outputs, to the classification unit 13, information indicating the keystroke pattern.

The classification unit 13 receives information indicating the keystroke pattern from the extraction unit 12. Based on the keystroke pattern, the classification unit 13 classifies student's approach to the task (S3). Thereafter, the classification unit 13 may transmit information indicating the type for each student to the management server 200 (FIG. 12) via the communication network. The information indicating the type for each student is stored in the management server 200.

As above, the operation of the information processing device 10 according to the present first example embodiment ends.

### Effects of Present Example Embodiment

According to the configuration of the present example embodiment, the collection unit 11 collects keystroke data indicating the operation input amount to a user terminal 100. The extraction unit 12 extracts a keystroke pattern indicating a feature of an operation input to the user terminal 100 from the keystroke data. Based on the keystroke pattern, the classification unit 13 classifies student's approach to the task.

The type of student's approach to the task reflects not only the qualities and abilities of the student but also the influence of the physical condition, lack of sleep, and the like of the student. In online classes, when a technique for complementing the student's approach to the task is provided, the teacher can understand the qualities and abilities of the student, for example, concentration and comprehension, and therefore the teacher can perform instruction suitable for the student. By grasping the type of student's approach to the task, the teacher can quickly capture student's abnormality even in the online classes.

### Second Example Embodiment

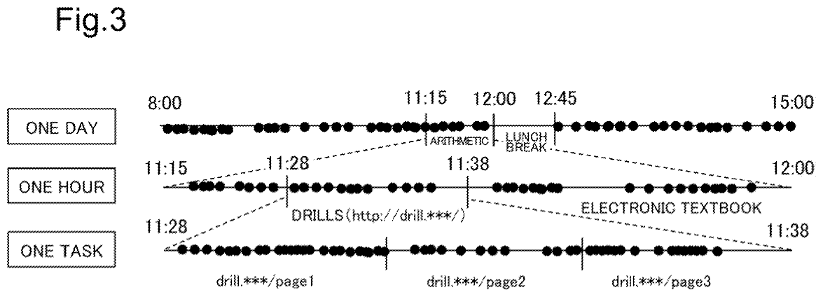

The second example embodiment will be described with reference to FIGS. 3 to 7. In the present second example embodiment, an example of the classification described in the first example embodiment will be described. Here, the classification means sorting student's approaches to the task into any type (class). In the present second example embodiment, an example of the type of content of class described in the first example embodiment will be described.

The configuration of an information processing device 20 (FIG. 1) according to the present second example embodiment is the same as the configuration of the information processing device 10 according to the first example embodiment. In the present second example embodiment, the description regarding the configuration and operations of the information processing device 10 in the first example embodiment is cited, and the description regarding the common configuration and operations of the information processing device 20 is omitted.

### Example of Keystroke Data

FIG. 3 illustrates an example of keystroke data indicating an operation input amount to the user terminal 100. FIG. 3 illustrates three types of keystroke data having different scales of time. In FIG. 3, the time axis is represented by a horizontal line, and the operation input is represented by a black dot on the horizontal line.

In FIG. 3, the keystroke data in the uppermost row represents an operation input amount from 8:00 to 15:00 on a certain day. The keystroke data in the middle represents an operation input amount for a class hour from 11:15 to 12:00 on the same day. With reference to FIG. 3, a mathematics class is given from 11:15 to 12:00.

In FIG. 3, the keystroke data in the bottommost row represents the operation input amount for one task from 11:28 to 11:38 on the same day. With reference to FIG. 3, from 11:28 to 11:38, a drill available on a web page in a website identified by the URL http://drill.***/ is used.

The target of classification by the classification unit 13 (FIG. 1) of the information processing device 20 is any of the three types of keystroke data illustrated in FIG. 3. However, the shorter the time width of the keystroke data is, the clearer characteristics of the qualities and abilities of the student such as the concentration and the comprehension of the student are more likely to appear. In the present first example embodiment, the classification unit 13 classifies student's approach to the task based on the keystroke data indicating the operation input amount during one task.

### (Non-Working Time Rate; Example of Keystroke Pattern)

The non-working time rate described in the first example embodiment will be described with reference to FIG. 4. FIG. 4 is a view illustrating an example of a keystroke pattern indicating an operation input amount during one task. As described in the first example embodiment, the non-working time rate represents a ratio of a length of time (hereinafter, may be referred to as non-working time) during which there is no operation input to the user terminal 100 to the time limit for the task.

In FIG. 4, T represents the length of time during which the student works on the task. TSN represents the length of time during which there is no operation input to the user terminal 100 for a certain period of time or more. SN (N=1 to n) is a value obtained by dividing TSN by T. The method of determining the certain period of time is discretionary, but the teacher may determine the certain period of time based on the difficulty level of the task, the grade of the student, the type of the instruction subject, and the like.

In one example, the non-working time rate is a weighted arithmetic mean of the non-working time SN. The non-working time rate is calculated by the classification unit 13 of the information processing device 20 in accordance with the following expression.

$$NON - WORKING TIME RATE = \sqrt{{\sum }_{N = 1}^{n} {S}_{N}^{2}} = ( \frac{1}{T} \sqrt{{\sum }_{N = 1}^{n} {T}_{SN}^{2}} ) \qquad [ Math . 1 ]$$

It is assumed that, for example, when a task is given with a time limit of 10 minutes, a first student considers for 5 minutes of the first half and answers for 5 minutes of the second half. In this case, the non-working time rate for the first student is 0.5(=√ (52)/10). On the other hand, it is assumed that a second student interrupts the work for 2.5 minutes twice (5 minutes in total). In this case, the non-working time rate for the second student is 0.35 (=√ (2.52×2)/10).

As in the present example, the first student and the second student have the same lengths of time for working on, but the first student and the second student have different non-working time rates. The non-working time rate (an example of a keystroke pattern) represents the characteristics and personality of the student regarding approach to the task.

### Example of Classification of Student's Approach to the Task

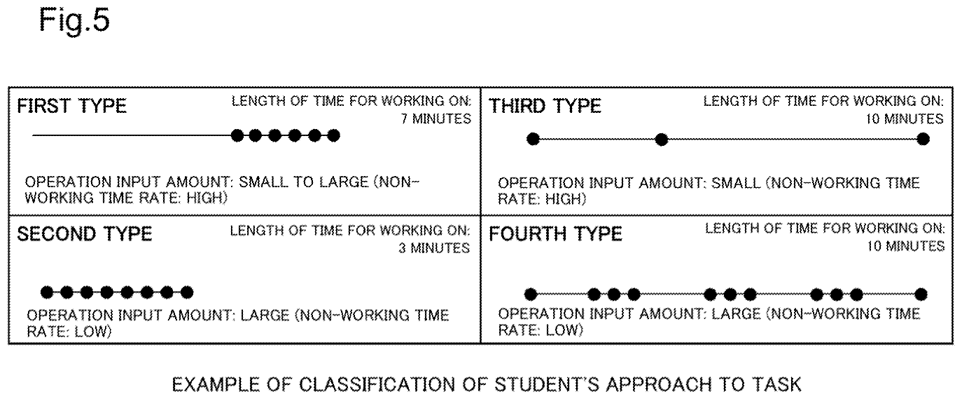

An example of classification of student's approach to the task will be described with reference to FIG. 5. FIG. 5 illustrates four types.

It is assumed that a task with a time limit of 10 minutes is given to a student. It is assumed that the mean length of time for working on of all students in the class is 7 minutes. In the present example, student's approach to the task is classified into any of the four types based on the operation input amount, the non-working time rate, and the length of time for working on.

As illustrated in FIG. 5, in the first type, the non-working time rate is higher and the length of time for working on is mean. In the upper left keystroke data exemplified as the first type, operation inputs are concentrated in the second half of the time period. For example, the student is regarded to have sufficiently considered a solution in the time period of the first half and then answered.

In the second type, the non-working time rate is low and the length of time for working on is short. In the lower left keystroke data exemplified as the second type, there is little non-working time. For example, the student is regarded to have immediately conceived a solution and immediately answered.

In the third type, the non-working time rate is high and the length of time for working on is long. In the upper right keystroke data exemplified as the third type, most of the keystroke data is the non-working time. For example, the student is regarded to have not been able to concentrate on the task.

In the fourth type, the non-working time rate is low and the length of time for working on is long. In the lower right keystroke data exemplified as the fourth type, most of the keystroke data is the working time. For example, the student is regarded to have started to answer but not conceived a solution.

Note that the classification described here is merely an example. It is not necessarily possible to accurately determine student's approach to the task based on the classification. Rather, the teacher should support the student at an appropriate timing with reference to the classification. The teacher should pay attention to abnormality of the student by grasping how the type of one student transitions with time.

### First Modification

In one modification, the classification unit 13 outputs information indicating time series of types of student's approaches to the task.

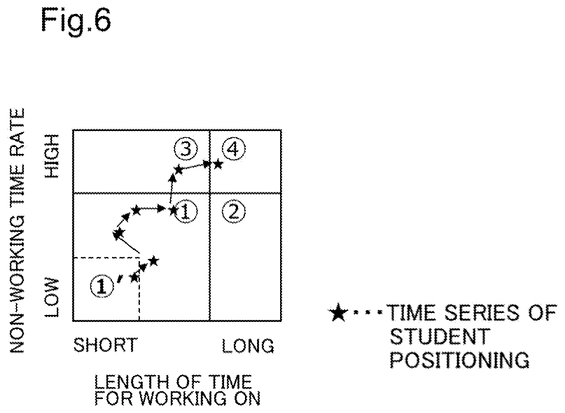

An example of information output by the classification unit 13 will be described with reference to FIG. 6. The map illustrated in FIG. 6 indicates how student's approach to the task transitions with time. In the map illustrated in FIG. 6, the horizontal axis represents the length of time for working on. The vertical axis represents the non-working time rate. Each frame dividing the map corresponds to one type.

In the present example, student's approach to the task is classified into four types. The star marks in FIG. 6 are time series of positioning of one student on the map. The arrows connecting the star marks represent the direction of time.

According to the configuration of the present first modification, since the teacher can grasp the change in type of one student, it is possible to quickly notice the abnormality of the student and support the student at an appropriate timing.

### Second Modification

In one modification, how the non-working time rate can be calculated when two or more tasks are consecutively performed in the same class and in the same instruction subject will be described. As described in the first example embodiment, the non-working time rate represents a ratio of a length of time during which there is no operation input to the user terminal 100 to a time limit for a task.

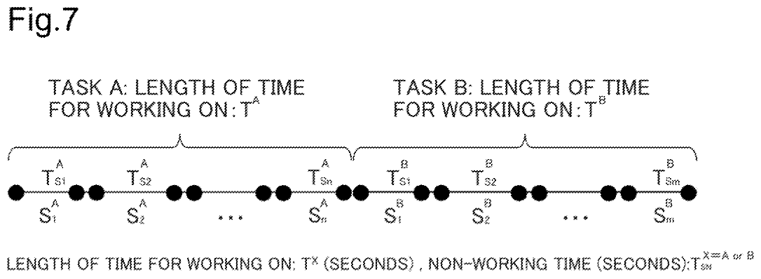

FIG. 7 is a view illustrating an example of a keystroke pattern indicating an operation input amount while two tasks A and B are consecutively performed.

In FIG. 7, TA represents the length of time during which the student works on the task A. TB represents the length of time during which the student works on the task B. TXSN (X represents A or B) represents the length of time during which there is no operation input to the user terminal 100 for a certain period of time or more during a task X. SXN (N=1 to n) is a value obtained by dividing TXSN by TX. The method of determining the certain period of time is discretionary, but the teacher may determine the certain period of time based on the difficulty level of the task, the grade of the student, the type of the instruction subject, and the like.

In one example, the non-working time rate is calculated by the classification unit 13 of the information processing device 20 in accordance with the following expression.

$$NON - WORKING TIME RATE = \sqrt{{\sum }_{N = 1}^{N} {S}_{N}^{{x}^{2}}} = \frac{1}{{T}^{x}} \sqrt{{\sum }_{N = 1}^{N} {T}_{SN}^{{x}^{2}}} = \frac{1}{{T}^{A} + {T}^{B}} \sqrt{{\sum }_{N = 1}^{n} {T}_{SN}^{{A}^{2}} + {\sum }_{N = 1}^{m} {T}_{SN}^{{B}^{2}}} \qquad [ Math . 2 ]$$

According to the configuration of the present second modification, the non-working time rate can be calculated even when two or more tasks are consecutively performed in the same class and in the same instruction subject.

### Effects of Present Example Embodiment

According to the configuration of the present example embodiment, the collection unit 11 collects keystroke data indicating the operation input amount to a user terminal 100. The extraction unit 12 extracts a keystroke pattern indicating a feature of an operation input to the user terminal 100 from the keystroke data. Based on the keystroke pattern, the classification unit 13 classifies student's approach to the task.

The type of student's approach to the task reflects not only the qualities and abilities of the student but also the influence of the physical condition, lack of sleep, and the like of the student. In online classes, when a technique for complementing the student's approach to the task is provided, the teacher can understand the qualities and abilities of the student, for example, concentration and comprehension, and therefore the teacher can perform instruction suitable for the student. By grasping the type of student's approach to the task, the teacher can quickly capture student's abnormality even in the online classes.

### Third Example Embodiment

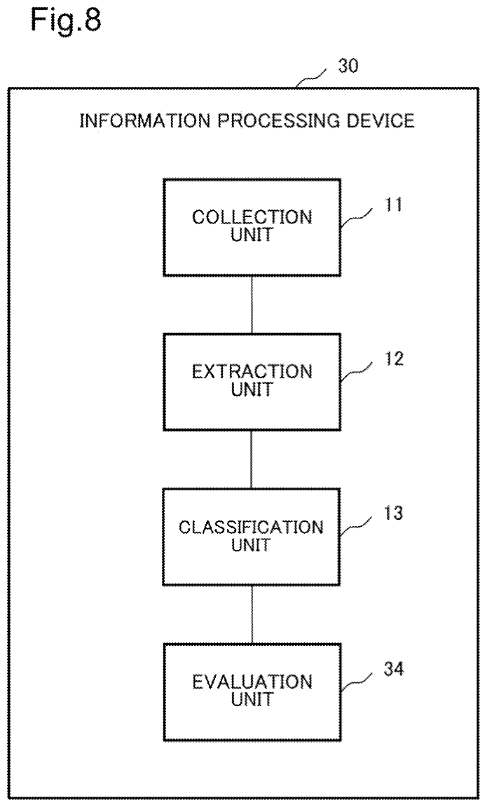

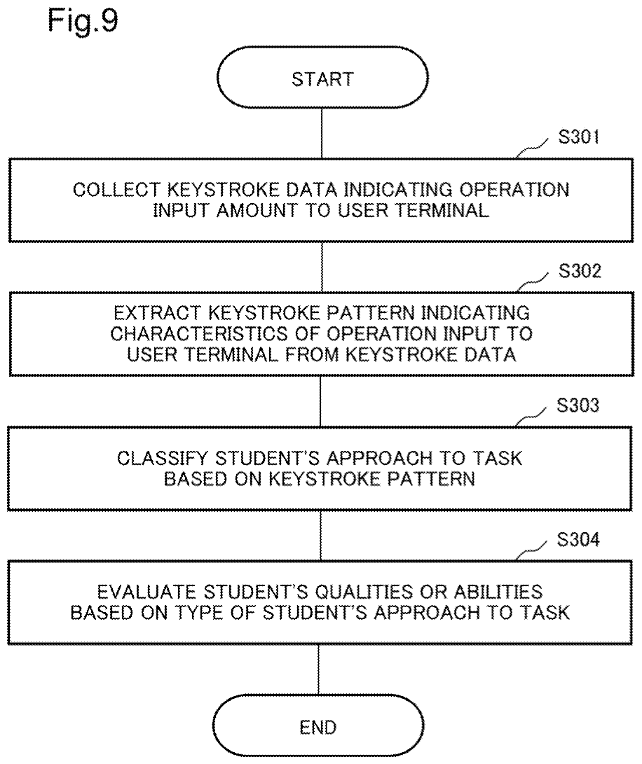

The third example embodiment will be described with reference to FIGS. 8 and 9. In the present third example embodiment, the configuration of providing reference information for the teacher to evaluate qualities or abilities of the student will be described.

### (Information Processing Device 30)

The configuration of an information processing device 30 according to the present third example embodiment will be described with reference to FIG. 8. FIG. 8 is a block diagram illustrating the configuration of the information processing device 30. As illustrated in FIG. 8, the information processing device 30 includes the collection unit 11, the extraction unit 12, and the classification unit 13. The information processing device 30 further includes an evaluation unit 34. Each component of the information processing device 30 will be described below.

The evaluation unit 34 evaluates qualities or abilities of the student based on the type of student's approach to the task. The evaluation unit 34 is an example of an evaluation means.

In one example, the evaluation unit 34 receives information indicating the type for each student from the classification unit 13. Here, the type of a certain student represents the student's approach to the task. The evaluation unit 34 calculates an index as a reference for the teacher to evaluate qualities or abilities of the student. However, the index may be simple reference information for the teacher to evaluate the student.

In the first example, the evaluation unit 34 calculates an index indicating the student's comprehension based on the type of the student's approach to the task and accuracy of the answer In the present example, the evaluation unit 34 acquires, from the management server 200, information indicating the accuracy of the student's answer to the task. Alternatively, the evaluation unit 34 may acquire, from the user terminal 100 of the teacher, information indicating accuracy of the answer input to the user terminal 100 by the teacher.

Then, the evaluation unit 34 calculates an index indicating the student's comprehension from a combination of the type of student's approach to the task and the accuracy of the answer. For example, the index indicating the student's comprehension is a function of a first parameter corresponding to the type of the student's approach to the task and a second parameter corresponding to a student's behavior.

In the second example, the evaluation unit 34 calculates an index indicating the concentration of the student based on the keystroke pattern and the student's behavior. In the present example, the evaluation unit 34 acquires, from the user terminal 100 of the student, data of a face image of the student photographed by the user terminal 100.

The evaluation unit 34 detects that the student is looking away or absence of the student, for example, through image analysis on the data of the face image of the student. The evaluation unit 34 can use an existing technique such as gaze detection or eyelid opening/closing rate detection in order to perform image analysis on the data of the face image of the student. Alternatively, the evaluation unit 34 may acquire, from the user terminal 100 of the teacher, the information indicating the student's behavior input to the user terminal 100 by the teacher.

Then, the evaluation unit 34 calculates an index indicating the concentration of the student from the combination of the working time indicated by the keystroke pattern and the student's behavior. For example, the index indicating the concentration of the student is a function of a first parameter corresponding to the working time indicated by the keystroke pattern and a second parameter corresponding to the student's behavior.

Furthermore, the evaluation unit 34 may create a report to be submitted to an education-related institution or an educator based on information indicating the type of student's approach to the task. For example, an index for each instruction subject is described in the report. This allows the education-related institution or the educator to obtain information indicating the evaluation of a student that is not based on subjective judgment of the teacher.

### (Operation of Information Processing Device 30)

An example of the operation of the information processing device 30 according to the present third example embodiment will be described with reference to FIG. 9. FIG. 9 is a flowchart illustrating a flow of processing executed by each unit of the information processing device 30.

As illustrated in FIG. 9, the collection unit 11 collects keystroke data indicating the operation input amount to the user terminal 100 (S301). The collection unit 11 outputs the keystroke data collected from the user terminal 100 to the extraction unit 12.

The extraction unit 12 receives, from the collection unit 11, the keystroke data collected from the user terminal 100. The extraction unit 12 extracts, from the keystroke data, a keystroke pattern indicating a feature of an operation input to the user terminal 100 (S302). The extraction unit 12 outputs, to the classification unit 13, information indicating the keystroke pattern.

The classification unit 13 receives information indicating the keystroke pattern from the extraction unit 12. Based on the keystroke pattern, the classification unit 13 classifies student's approach to the task (S303). Thereafter, the classification unit 13 may transmit information indicating the type for each student to the management server 200 (FIG. 8) via the communication network. The information indicating the type for each student is stored in the management server 200. The classification unit 13 outputs, to the evaluation unit 34, information indicating the type of student's approach to the task.

The evaluation unit 34 receives, from the classification unit 13, information indicating the type of student's approach to the task. The evaluation unit 34 evaluates the qualities or abilities of the student based on the type of student's approach to the task (S304). For example, the evaluation unit 34 calculates an index indicating the evaluation of the qualities or abilities of the student.

As above, the operation of the information processing device 30 according to the present third example embodiment ends.

### Second Example of Classification of Student's Approach to the Task

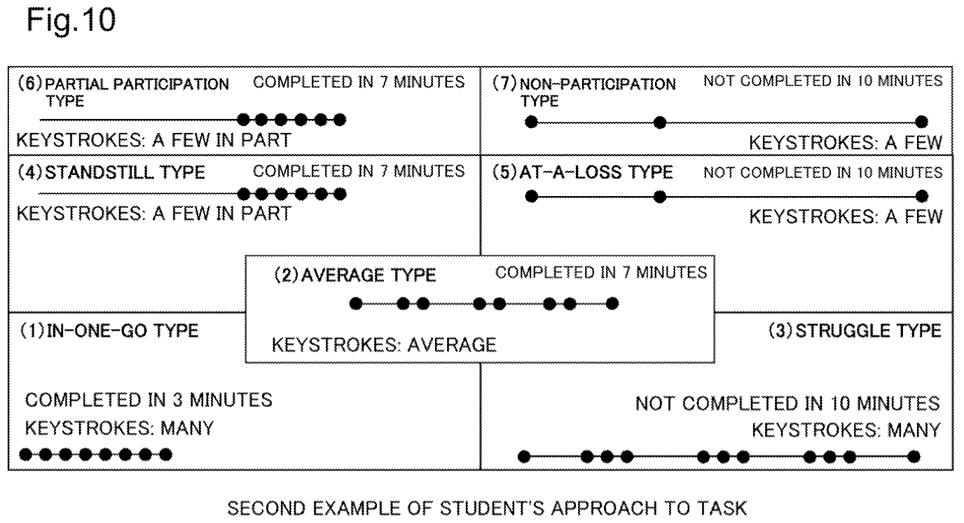

The second example of classification of student's approach to the task will be described with reference to FIG. 10. FIG. 10 illustrates seven types.

The type illustrated in FIG. 10 has additional three types in comparison with the type illustrated in FIG. 5. Specifically, the seven types illustrated in FIG. 10 further include an “average type” in addition to the four types illustrated in FIG. 5. In the seven types illustrated in FIG. 10, the first type and the third type illustrated in FIG. 5 are each divided into two types according to the student's approach to class.

Both of a “partial participation type” and a “standstill type” illustrated in FIG. 10 have the same keystroke pattern as that of the first type illustrated in FIG. 5. Both of an “at-a-loss type” and a “non-participation type” illustrated in FIG. 10 have the same keystroke pattern as that of the third type illustrated in FIG. 5.

An “in-one-go type” (corresponding to the second type in FIG. 5) indicates that the student has immediately completed the task.

The “partial participation type” (corresponding to the first type in FIG. 5) indicates that the student does not concentrate on the task.

The “standstill type” (corresponding to the first type in FIG. 5) indicates that the student has sufficiently considered the solution.

A “struggle type” (corresponding to the fourth type in FIG. 5) indicates that the student has had trial and error.

The “non-participation type” (corresponding to the third type in FIG. 5) indicates that the student has hardly started the task.

The “at-a-loss type” (corresponding to the third type in FIG. 5) indicates that the student has not found the solution.

The “average type” (no corresponding type in FIG. 5) represents a mean keystroke pattern and working time of students in one class or one group. The mean keystroke pattern is obtained by performing statistical processing on a plurality of keystroke data.

Note that the interpretation of the characteristics of the students represented by each type (that is, personality regarding approach to the task) is merely an example.

### Modification

In the present modification, the evaluation unit 34 evaluates the qualities or abilities of the student based on a combination of the type of the student represented by the keystroke pattern of the student and the test result.

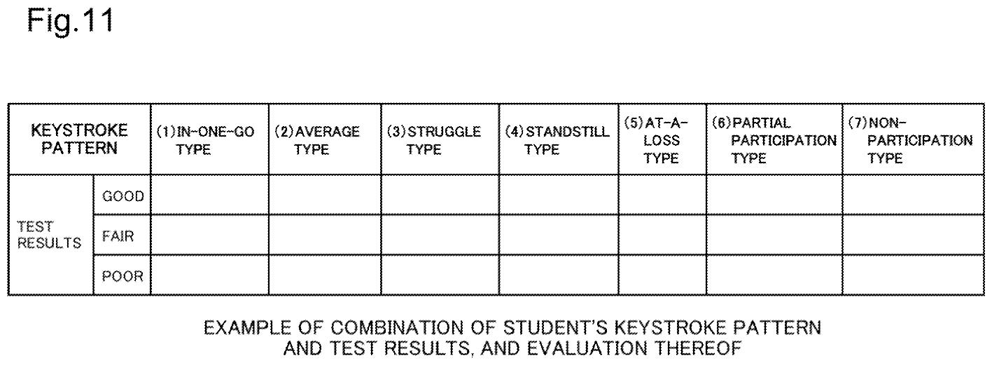

FIG. 11 is an example of combination of the type of a student's keystroke pattern and a test result and an evaluation. In the table presented in FIG. 11, the vertical axis represents the type of the test result, and the horizontal axis represents the type of the keystroke pattern. The test result illustrated in FIG. 11 represents a student's evaluation point (score) regarding a task described in a digital textbook or the like. The seven types illustrated in FIG. 11 are the same as those illustrated in FIG. 10.

In the table presented in FIG. 11, the test results are classified into three types of “good”, “fair”, and “poor”. Similarly to FIG. 10, the type of the keystroke pattern is classified into seven types. The data of the table presented in FIG. 11 is stored in, for example, the management server 200 (FIG. 12). The classification of the test result and the keystroke pattern is not limited.

In the table presented in FIG. 11, a teacher's comment regarding student's approach to the task is written in a blank cell where a row corresponding to the type of one test result and a column corresponding to the type of one keystroke pattern intersect.

For example, for each blank cell, the teacher writes, into the user terminal 100, experience such as frequent cases regarding how the student approaches to the task, findings (viewpoints) obtained from instruction to the student, and the like. The information such as the findings and experiences written in the user terminal 100 of the teacher is transmitted to the management server 200 via the network. Then, the management server 200 accumulates information for understanding the meaning of the combination of the type of keystroke patterns and the type of test results. The information stored in the management server 200 can be accessed from the user terminal 100 of any teacher other than the teacher who has transmitted the information to the management server 200. Due to this, findings and experiences obtained by each teacher are shared among teachers.

In one example, the evaluation unit 34 receives information indicating student's approach to the task from the classification unit 13, and acquires data of an answer to the task from the user terminal 100 of the student. The evaluation unit 34 calculates an evaluation point of the student related to the task by analyzing the data of the answer to the task. The evaluation unit 34 classifies the test result into any of the three types of “good”, “fair”, and “poor” based on the calculated evaluation point.

The evaluation unit 34 evaluates student's approach to the task based on the classification of the test result calculated earlier and the type of the student specified by the classification unit 13. For example, the evaluation unit 34 acquires, from the management server 200, information indicating findings and experiences written by the teacher with reference to the data in the table presented in FIG. 11. The evaluation unit 34 outputs information indicating the findings and experiences written by the teacher as an evaluation result directly or indirectly indicating the qualities or abilities of the student.

### Effects of Present Example Embodiment

According to the configuration of the present example embodiment, the collection unit 11 collects keystroke data indicating the operation input amount to a user terminal 100. The extraction unit 12 extracts a keystroke pattern indicating a feature of an operation input to the user terminal 100 from the keystroke data. Based on the keystroke pattern, the classification unit 13 classifies student's approach to the task.

The type of student's approach to the task reflects not only the qualities and abilities of the student but also the influence of the physical condition, lack of sleep, and the like of the student. In online classes, when a technique for complementing the student's approach to the task is provided, the teacher can understand the qualities and abilities of the student, for example, concentration and comprehension, and therefore the teacher can perform instruction suitable for the student. By grasping the type of student's approach to the task, the teacher can quickly capture student's abnormality even in the online classes.

Furthermore, according to the configuration of the present example embodiment, the evaluation unit 34 evaluates qualities or abilities of the student based on the type of student's approach to the task. The teacher can use the evaluation results by the evaluation unit 34 as a reference for himself/herself to evaluate the qualities or abilities of the student.

### Fourth Example Embodiment

The fourth example embodiment will be described with reference to FIG. 12. In the present fourth example embodiment, a communication system including any of the information processing devices 10, 20, and 30 according to the first to third example embodiments will be described. In the present fourth example embodiment, the same reference signs are given to the components common to the first to third example embodiments, and the description thereof will be omitted.

### (Communication System 1)

FIG. 12 is a view schematically illustrating an example of the configuration of a communication system 1 according to the present fourth example embodiment. As illustrated in FIG. 12, the communication system 1 includes the information processing device 10 (20 or 30), a plurality of user terminals 100, and the management server 200. Here, the “information processing device 10 (20 or 30)” means any of the information processing devices 10, 20, and 30 according to the first to third example embodiments.

The plurality of user terminals 100 include a first user terminal used by the teacher and a second user terminal used by each student. For example, each user terminal 100 is a personal computer or a tablet terminal.

The plurality of user terminals 100 and the information processing device 10 (20 or 30) are communicably connected via a discretionary communication network. Various data are transmitted and received between each user terminal 100 and the information processing device 10 (20 or 30). In particular, log information is transmitted from each user terminal 100 to the information processing device 10 (20 or 30).

The log information includes information indicating content used in the user terminal 100. The log information may include at least one of an operation log, an authentication log, an access log, a communication log, a call log, and an event log.

By analyzing the log information received from each of the user terminals 100, the information processing device 10 (20 or 30) generates the information indicating the class classification and the information regarding the content used, as described in the first to third example embodiments. Then, the information processing device 10 (20 or 30) records the generated information into the management server 200.

Furthermore, as described in the third example embodiment, the information processing device 10 (20 or 30) may create a report (FIG. 7) including information indicating the class classification and information regarding the content. The information processing device 10 (20 or 30) may store the created report data into the management server 200. This allows the education-related institution or the educator to easily refer to or acquire the data of the report stored in the management server 200 by connecting to the network using the first user terminal 100.

For security, an access restriction may be set in the management server 200 so that the second user terminal 100 used by the student cannot access the management server 200. This is because students should be prevented from being capable of viewing reports related to other students, from point of view of protection of personal information and privacy. Since the report corresponds to confidential information on the school side, no student should be capable of referring to or acquiring data of reports even if the reports are related to the students themselves.

### Effects of Present Example Embodiment

According to the configuration of the present example embodiment, the collection unit 11 collects keystroke data indicating the operation input amount to a user terminal 100. The extraction unit 12 extracts a keystroke pattern indicating a feature of an operation input to the user terminal 100 from the keystroke data. Based on the keystroke pattern, the classification unit 13 classifies student's approach to the task.

The type of student's approach to the task reflects not only the qualities and abilities of the student but also the influence of the physical condition, lack of sleep, and the like of the student. In online classes, when a technique for complementing the student's approach to the task is provided, the teacher can understand the qualities and abilities of the student, for example, concentration and comprehension, and therefore the teacher can perform instruction suitable for the student. By grasping the type of student's approach to the task, the teacher can quickly capture student's abnormality even in the online classes.

### (Regarding Hardware Configuration)

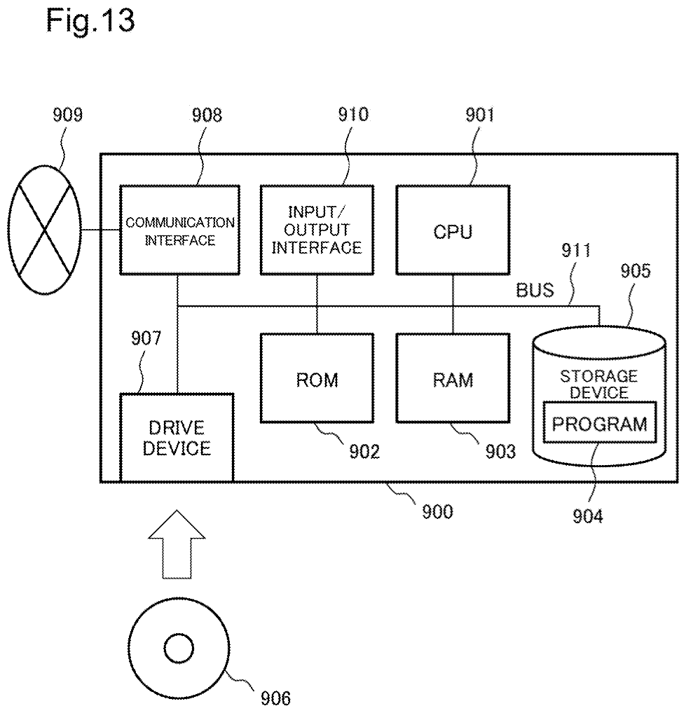

Each component of the information processing devices 10, 20, and 30 described in the first to third example embodiments indicates a block of a functional unit. Some or all of these components are implemented by an information processing device 900 as illustrated in FIG. 13, for example. FIG. 13 is a block diagram illustrating an example of the hardware configuration of the information processing device 900.

As illustrated in FIG. 13, the information processing device 900 includes the following configuration as an example.
CPU (Central Processing Unit) 901
ROM (Read Only Memory) 902
RAM (Random Access Memory) 903
Program 904 to be loaded into the RAM 903
Storage device 905 storing the program 904
Drive device 907 reading and writing a recording medium 906
Communication interface 908 connected to a communication network 909
Input/output interface 910 performing input/output of data
Bus 911 connecting each components

Each component of the information processing devices 10, 20, and 30 described in the first to third example embodiments is implemented by the CPU 901 reading and executing the program 904 that implements these functions. The program 904 that implements the functions of each component is stored in the storage device 905 or the ROM 902 in advance, for example, and the CPU 901 loads, into the RAM 903, and executes the program 904 as necessary. The program 904 may be supplied to the CPU 901 via the communication network 909, or may be stored in the recording medium 906 in advance, read by the drive device 907, and supplied to the CPU 901.

According to the above configuration, the information processing devices 10, 20, and 30 described in the first to third example embodiments are implemented as hardware. Therefore, it is possible to achieve effects similar to the effects described in any of the first to third example embodiments.

### (Supplementary Notes)

One aspect of the present invention is also described as the following supplementary notes, but is not limited to the following.

### (Supplementary Note 1)

An information processing device including:

a collection means configured to collect keystroke data indicating an operation input amount to a user terminal;

an extraction means configured to extract, from the keystroke data, a keystroke pattern indicating a feature of an operation input to the user terminal; and

a classification means configured to classify approach of a student to a task, based on the keystroke pattern.

### (Supplementary Note 2)

The information processing device according to Supplementary Note 1, in which the keystroke pattern includes a length of non-working time in which there is no operation input to the user terminal and a length of time for working on that is required for the task by the student.

### (Supplementary Note 3)

The information processing device according to Supplementary Note 1 or 2 further including:

an evaluation means configured to evaluate qualities or abilities of the student based on a type of the approach of the student to the task.

### (Supplementary Note 4)

The information processing device according to Supplementary Note 3, in which the evaluation means

calculates an index indicating comprehension of the student based on a type of the approach of the student to the task and accuracy of an answer.

### (Supplementary Note 5)

The information processing device according to Supplementary Note 3, in which the evaluation means

calculates an index indicating concentration of the student based on the keystroke pattern and a behavior of the student.

### (Supplementary Note 6)

The information processing device according to any one of Supplementary Notes 1 to 5, in which

the classification means outputs information indicating time series of a type of the approach of the student to the task.

### (Supplementary Note 7)

An information processing method including:

collecting keystroke data indicating an operation input amount to a user terminal; extracting, from the keystroke data, a keystroke pattern indicating a feature of an operation input to the user terminal; and

classifying approach of a student to a task, based on the keystroke pattern.

### (Supplementary Note 8)

A program for causing a computer to execute

collecting keystroke data indicating an operation input amount to a user terminal,

extracting, from the keystroke data, a keystroke pattern indicating a feature of an operation input to the user terminal, and

classifying approach of a student to a task, based on the keystroke pattern.

### (Supplementary Note 9)

The information processing device according to any one of Supplementary Notes 1 to 6, in which

the collection means collects log information from the user terminal and extracts the keystroke data from the log information.

### (Supplementary Note 10)

The information processing device according to Supplementary Note 9, in which the log information includes at least one of an operation log, an authentication log, an access log, a communication log, a call log, and an event log.

### (Supplementary Note 11)

The information processing device according to any one of Supplementary Notes 1 to 6, wherein

the classification means classifies the approach of the student to the task into four based on two of the non-working time rates of high and low and two of the lengths of time for working on of long and short.

The previous description of embodiments is provided to enable a person skilled in the art to make and use the present invention. Moreover, various modifications to these example embodiments will be readily apparent to those skilled in the art, and the generic principles and specific examples defined herein may be applied to other embodiments without the use of inventive faculty. Therefore, the present invention is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing device comprising:
a memory configured to store instructions; and
at least one processor configured to execute the instructions to perform:
collecting keystroke data indicating an operation input amount to a user terminal;
extracting, from the keystroke data, a keystroke pattern indicating a feature of an operation input to the user terminal; and
classifying approach of a student to a task, based on the keystroke pattern.

2. The information processing device according to claim 1, wherein
the keystroke pattern includes a length of non-working time in which there is no operation input to the user terminal and a length of time for working on that is required for the task by the student.

3. The information processing device according to claim 1, wherein
the at least one processor is further configured to execute the instructions to perform:
evaluating qualities or abilities of the student based on a type of the approach of the student to the task.

4. The information processing device according to claim 3, wherein
the at least one processor is configured to execute the instructions to perform:
calculating an index indicating comprehension of the student based on the type of the approach of the student to the task and accuracy of an answer.

5. The information processing device according to claim 3, wherein
the at least one processor is configured to execute the instructions to perform:
calculating an index indicating concentration of the student based on the keystroke pattern and a behavior of the student.

6. The information processing device according to claim 1, wherein
the at least one processor is configured to execute the instructions to perform:
outputting information indicating time series of a type of the approach of the student to the task.

7. An information processing method comprising:
collecting keystroke data indicating an operation input amount to a user terminal;
extracting, from the keystroke data, a keystroke pattern indicating a feature of an operation input to the user terminal; and
classifying approach of a student to a task, based on the keystroke pattern.

8. A non-transitory recording medium storing a program for causing a computer to execute
collecting keystroke data indicating an operation input amount to a user terminal, extracting, from the keystroke data, a keystroke pattern indicating a feature of an operation input to the user terminal, and
classifying approach of a student to a task, based on the keystroke pattern.
